(19) United States
(12) Patent Application Publication
(10) Pub. No.: US 2026/0058389 A1
(43) Pub. Date: Feb. 26, 2026

(54) MALE CONNECTOR

(71) Applicant: Yazaki Corporation, Tokyo (JP)

(72) Inventors: Tomoyoshi FUKAYA, Makinohara-shi (JP); Syota SAKUMA, Tokyo (JP)

(73) Assignee: Yazaki Corporation, Tokyo (JP)

(21) Appl. No.: 19/299,959

(22) Filed: Aug. 14, 2025

(30) Foreign Application Priority Data
Aug. 21, 2024 (JP) 2024-139753

(51) Int. Cl. H01R 13/04; H01R 13/422; H01R 13/502

(52) U.S. Cl. CPC H01R 13/04; H01R 13/422; H01R 13/502

(57) ABSTRACT

A male terminal includes a rod-shaped portion, a pair of first protruding portions and a pair of second protruding portions. A male housing includes a cylindrical portion surrounding one end portion in a longitudinal direction of the male terminal to receive a mating connector, and a terminal retaining portion retaining the male terminal. A terminal insertion hole includes a press-fit portion into which a portion of the male terminal where a pair of first protruding portions and a pair of second protruding portions is press-fitted, and an accommodation portion formed at the side of the cylindrical portion further than the press-fit portion with a cross-sectional area being larger than that of the press-fit portion. A gap for receiving the thread burrs generated during the press-fit of the male connector is provided between an inner surface of the accommodation portion and the male connector.

### TECHNICAL FIELD

The present invention relates to a male connector comprising a male terminal and a male housing.

### BACKGROUND ART

There is a configuration shown in FIG. 5 (see Patent Document 1) as an example of a conventional male connector. The male connector shown in FIG. 5 includes a plurality of male terminals 505 and a connector housing 503 retaining the plurality of male terminals 505.

In the connector housing 503, terminal insertion holes 537 and press-fit shoulder accommodation portions 539 continuing thereto are formed in a plural. The terminal insertion hole 537 is formed by being surrounded by press-fit retaining wall portions 540. Between the press-fit retaining wall portions 540 of the adjacent terminal insertion holes 537, a bending allowance portion 541 is formed therein. In the terminal insertion hole 537, a press-fit retaining portion 553 of the male connector 505 is press fitted. In the press-fit shoulder accommodation portion 539, a press-fit shoulder portion 552 of the male connector 505 is press fitted.

Regarding the above-described connector, when the press-fit retaining portion 553 of the male terminal 505 is press fit into the terminal insertion hole 537, the press-fit retaining wall portions 540 is bent toward the side of the bending allowance portion 541. Therefore, a friction force between the press-fit retaining portion 553 and the press-fit retaining wall portions 540 becomes smaller such that it is possible to suppress the metal plating formed on the surface of the male connector 505 from peeling off while suppressing formation of the thread burrs. The thread burr can cause short circuits. Also, after the press fitting, the press-fit retaining wall portion 540 restores due to the elasticity and bites into the press-fit retaining portion 553. Therefore, the press-fit retaining portion 553 is retained by the press-fit retaining wall portion 540.

### CITATION LIST

### Patent Documents

[Patent Document 1] JP 2013-235772A

### SUMMARY OF THE INVENTION

### Technical Problem

In the above-described conventional connector, it is possible to suppress the formation of the thread burrs due to the metal plating of the male terminal 505 peeling off during the assembly, by providing the bending allowance portion 541 in the connector housing 503. However, since the connector housing 503 includes the bending allowance portion 541, there is a technical problem that a pitch between terminals becomes larger.

The present invention is made for achieving the goal of providing a male connector which can prevent the short circuits due to the thread burrs while narrowing the pitch between the terminals.

### Solution to Problem

The present invention is a male connector comprising a male terminal and a male housing, charactered in that a protruding portion protruding in a width direction of the male terminal is formed in the male terminal, the male housing comprises a cylindrical portion being configured to surround one end portion in a longitudinal direction of the male terminal and receive a mating connector, and a terminal retaining portion configured to retain the male terminal, the terminal retaining portion opens at a side of the cylindrical portion and the opposite side and includes a terminal insertion hole through which the male terminal is inserted, the terminal insertion hole comprises a press-fit portion into which a portion of the male terminal where the protruding portion is formed is press-fitted and an accommodation portion formed at the side of the cylindrical portion further than the press-fit portion with a cross-sectional area being larger than that of the press-fit portion, and a gap is provided between an inner surface of the accommodation portion and the male connector.

### Effect of the Invention

According to the present invention, it is possible to provide a male connector which can prevent the short circuits due to the thread burrs while narrowing the pitch between the terminals.

### BRIEF DESCRIPTION OF THE DRAWINGS

FIG. 1 is a front view of a male connector according to an embodiment of the present invention.

FIG. 2 is an exploded view showing the male connector in FIG. 1.

FIG. 3 is a sectional view along an A-A line in FIG. 1.

FIG. 4 is an enlarged view of a portion B in FIG. 3.

FIG. 5 is a sectional view showing a principle portion of a conventional male connector.

### DESCRIPTION OF EMBODIMENTS

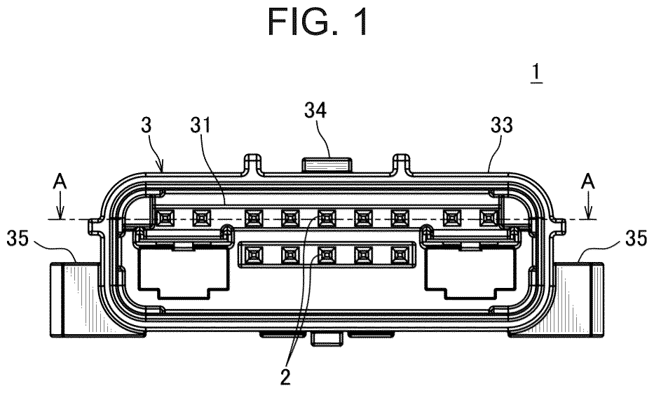

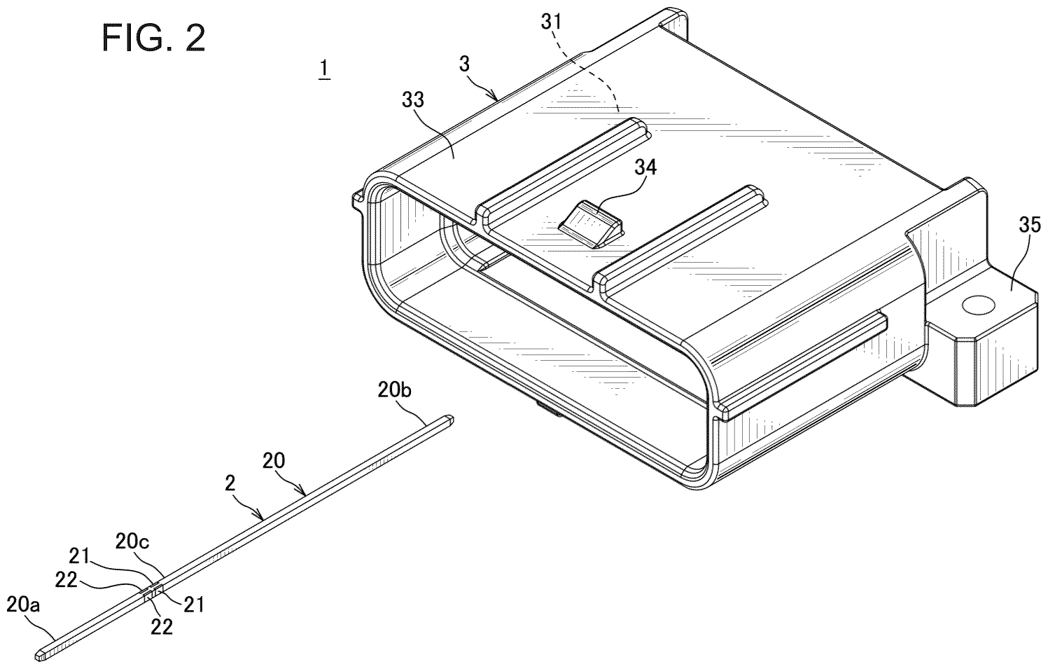

A “male connector” according to an embodiment of the present invention will be described with reference from FIG. 1 to FIG. 4.

A male connector 1 shown in FIG. 1 to FIG. 4 is fitted into a female connector as a mating connector. The male connector 1 includes a plurality of male connectors 2 and a male housing 3. Regrading the male connector 1, the male connector side in a fitting direction with respect to the female connector is referred to as a “front side”, and the opposite side is referred to as a “rear side”.

The male terminal 2 is obtained by performing the plating with tin or the like on a surface of a metallic base material. The male terminal 2 has a rod-shaped portion 20 extending straight across its whole length, and a pair of first protruding portions 21 and a pair of second protruding portions 22 protruding from both end portions in a width direction of the rod-shaped portion 20, within an intermediate portion 20c in a longitudinal direction of the rod-shaped portion 20.

The above-described “width direction of the rod-shaped portion 20 (also referred to as a width direction of the male terminal 2)” is a direction being orthogonal to the longitudinal direction of the rod-shaped portion 20, and a direction in which the plurality of male terminals 2 are arranged in the male connector 1.

The rod-shaped portion 20 is formed with a uniform cross-sectional area across its whole length (however, except for a tapered portion at one end and the other end thereof). The above-described “cross-sectional area” is an area of a cross section being orthogonal to the longitudinal direction of the rod-shaped portion 20. One end portion 20a in the longitudinal direction of the rod-shaped portion 20 is positioned inside the male housing 3 to be electrically connected to a female terminal of a female connector. The other end portion 20b in the longitudinal direction of the rod-shaped portion 20 is positioned outside the male housing 3 to be electrically connected to a substrate or the like.

The pair of first protruding portions 21 and the pair of second protruding portions 22 are separated in the longitudinal direction of the rod-shaped portion 20. The pair of first protruding portions 21 are positioned in the intermediate portion 20c of the rod-shaped portion 20 at the side of the other end portion 20b with respect to the pair of second protruding portions 22. The pair of second protruding portions 22 are positioned in the intermediate portion 20c of the rod-shaped portion 20 at the side of the one end portion 20a with respect to the pair of first protruding portions 21. The protruding length of the second protruding portion 22 from the rod-shaped portion 20 is formed to be larger than the protruding length of the first protruding portion 21 from the rod-shaped portion 20.

The male terminal 2 is formed with the portion where the pair of second protruding portions 22 are formed having the largest cross-sectional area in the longitudinal direction thereof, while with the portion where the pair of first protruding portions 21 are formed having the next largest cross-sectional area. The cross-sectional areas of the rest portions are uniform (however, except for the tapered portions at the one end and the other end). The above-described “cross-sectional area” is an area of a cross section being orthogonal to the longitudinal direction of the male terminal 2.

The male housing 3 is made of an insulating synthetic resin. The male housing 3 integrally includes a cylindrical portion 33, a terminal retaining portion 31, and a pair of fixing portions 35 being fixed to the substrate or the like with screws.

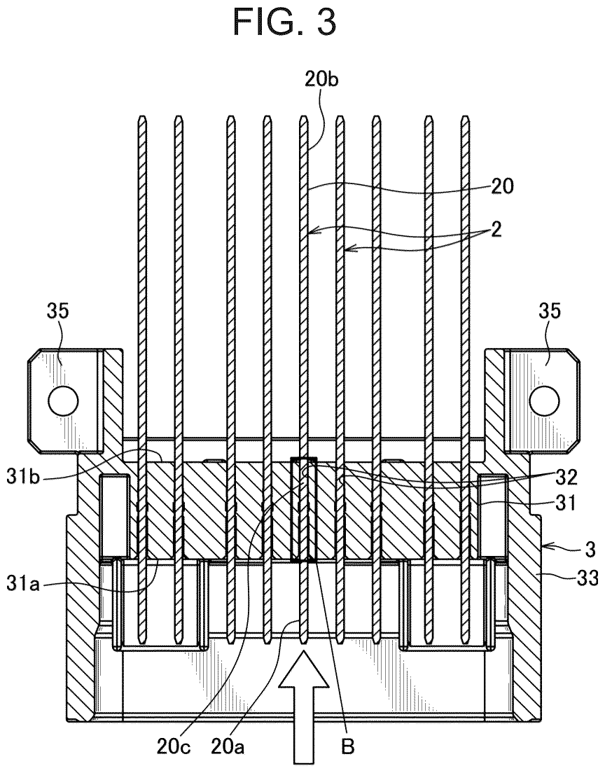

The cylindrical portion 33, as shown in FIG. 1 and FIG. 3, is configured to surround one end portion 20a of the male terminal 2. The cylindrical portion 33 receives the female connector from a front opening thereof.

The terminal retaining portion 31 is a portion for retaining the plurality of male terminals 2. The terminal retaining portion 31 is formed to block the opening at the rear side of the cylindrical portion 33. The terminal retaining portion 31 includes a plurality of terminal insertion holes 32 through which the male terminal 2 is inserted. The plurality of terminal insertion holes 32 are arranged in a direction being orthogonal to the connector fitting direction. Each terminal insertion hole 32 opens on the front-end surface 31a and the rear-end surface 31b of the terminal retaining portion 31. In other words, each terminal insertion hole 32 opens at the side of the cylindrical portion 33 (front side) and the opposite side (rear side).

The male terminal 2 is inserted through with respect to the terminal insertion hole 32 in the direction indicated by the arrow in FIG. 3. In other words, the male terminal 2 is inserted through the terminal insertion hole 32 from the side of the front-end surface 31a of the terminal retaining portion 31 with the other end portion 20b of the rod-shaped portion 20 as a leading end, and the other end portion 20b of the rod-shaped portion 20 protrudes outside of the terminal insertion hole 32 from the side of the rear-end surface 31b.

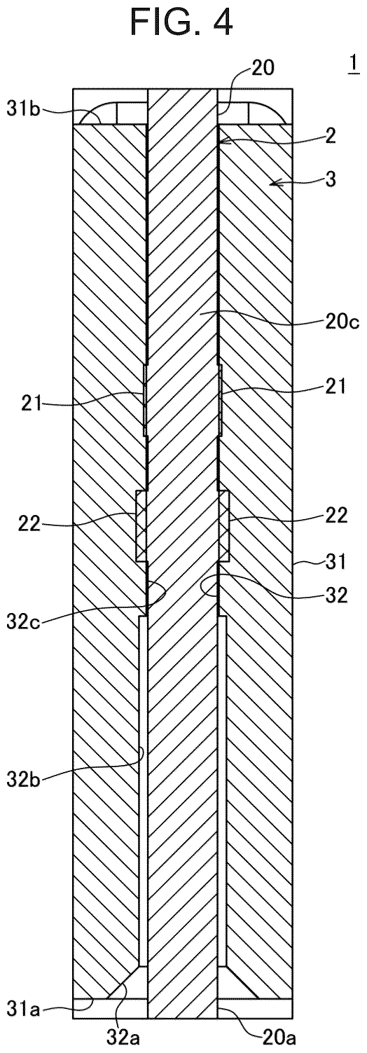

As shown in FIG. 4, each terminal insertion hole 32 is configured by a guide portion 32a, an accommodation portion 32b, and a press-fit portion 32c. The guide portion 32a, the accommodation portion 32b, and the press-fit portion 32c are arranged in this sequence from the side of the front-end surface 31a toward the side of the rear-end surface 31b of the terminal retaining portion 31.

The guide portion 32a is formed with the cross-sectional area (the area of the cross section being orthogonal to the front-rear direction) being gradually reduced as from the side of the front-end surface 31a toward the side of the rear-end surface 31b, that is, from the side of the cylindrical portion 33 (front side) toward the side of the accommodation portion 32b (rear side). The guide portion 32a introduces the male terminal 2 positioned in the space inside the cylindrical portion 33 to the inside of the terminal insertion hole 32 when the male terminal 2 is inserted through the terminal insertion hole 32.

The accommodation portion 32b is continuous with the guide portion 32a and extends to the side of the rear-end surface 31b. The accommodation portion 32b is formed with the cross-sectional area (the area of the cross section being orthogonal to the front-rear direction) being uniform across the whole length in the front-rear direction. As shown in FIG. 4, in the accommodation portion 32b, the portion in the male terminal 2 where the pair of first protruding portions 21 and the pair of second protruding portions 22 are not formed, that is, only the rod-shaped portion 20 is positioned therein. A gap is provided between the inner surface of the accommodation portion 32b and the rod-shaped portion 20.

The press-fit portion 32c is continuous with the accommodation portion 32b and extends until the rear-end surface 31b. The press-fit portion 32c is formed with the cross-sectional area (the area of the cross section being orthogonal to the front-rear direction) being uniform across the whole length in the front-rear direction. This cross-sectional area of the press-fit portion 32c is smaller than the cross-sectional area of the accommodation portion 32b. As shown in FIG. 4, in the press-fit portion 32c, the portion in the male terminal 2, where the pair of first protruding portions 21 and the pair of second protruding portions 22 are formed, are press-fitted. Therefore, the male terminal 2 is retained by the terminal retaining portion 31.

The male terminal 2, when being inserted through the terminal insertion hole 32, smoothly passes through the inside of the accommodation portion 32b, and subsequently, the pair of first protruding portions 21 and the pair of second protruding portions 22 come into contact with the inner surface of the press-fit portion 32c to be scraped such that the thread burrs occur. At this time, the resin residue is generated at the side of the male housing 3. The generated resin residue and the thread burrs remain in the accommodation portion 32b when the length thereof is within the accommodation portion 32b, and thus they are not beyond the front-end surface 31a of the terminal retaining portion 31. That is, they are not protruding to the outside of the terminal insertion hole 32. In a case when the resin residue and the thread burrs are not with the length within the accommodation portion 32b, they will be found and removed during the product inspection. Accordingly, it is possible to prevent the short circuits due to the thread burrs.

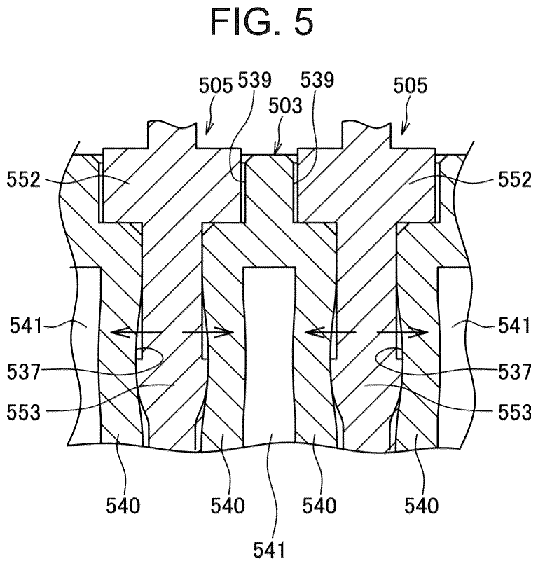

Regarding such male connector 1, it is unnecessary to form the bending allowance portion 541 between the adjacent press-fit retaining wall portions 540 of the terminal insertion hole 537 as in the conventional connector (see FIG. 5) such that it is possible to narrow the pitches between the terminals.

Also, in the male connector 1, the second protruding portions 22 with the larger protruding length are positioned at the side of the accommodation portion 32b than the first protruding portions 21. Therefore, when the male connector 2 is inserted through the terminal insertion hole 32, the first protruding portions 21 are priorly press-fitted into the press-fit portion 32c, and the second protruding portions 22 are press-fitted with the location where the first protruding portions 21 have passed through in a manner of being pressed to be widen. Accordingly, when compared with the case when the first protruding portion 21 is not formed, it is possible to perform the insertion of the male terminal 2 smoothly.

It is noted that the above-described embodiment merely shows a typical aspect of the present invention, and the present invention is not limited to this embodiment. That is, various modifications can be made without departing from the scope of the invention. Of course, such modifications will fall within the scope of the present invention as long as they still have the configurations according to the present invention.

### REFERENCE SIGNS LIST

1 male connector
2 male terminal
3 male housing
21 first protruding portion (protruding portion)
22 second protruding portion (protruding portion)
31 terminal retaining portion
32 terminal insertion hole
32a guide portion
32b accommodation portion
32c press-fit portion
33 cylindrical portion

What is claimed is:

1. A male connector, comprising a male terminal and a male housing,
wherein a protruding portion protruding in a width direction of the male terminal is formed in the male terminal,
the male housing comprises a cylindrical portion being configured to surround one end portion in a longitudinal direction of the male terminal and receive a mating connector, and a terminal retaining portion configured to retain the male terminal,
the terminal retaining portion opens at a side of the cylindrical portion and the opposite side and includes a terminal insertion hole through which the male terminal is inserted,
the terminal insertion hole comprises a press-fit portion into which a portion of the male terminal where the protruding portion is formed is press-fitted and an accommodation portion formed at the side of the cylindrical portion further than the press-fit portion with a cross-sectional area being larger than that of the press-fit portion, and
a gap is provided between an inner surface of the accommodation portion and the male connector.

2. The male connector according to claim 1, wherein the terminal insertion hole comprises a guide portion formed at the side of the cylindrical portion further than the accommodation portion, while with a cross-sectional area being gradually reduced as from the side of the cylindrical portion toward the side of the accommodation portion.

3. The male connector according to claim 1,
wherein the male terminal includes a first protruding portion and a second protruding portion as the protruding portion,
the second protruding portion is positioned at the side of the accommodation portion further than the first protruding portion, and
a protruding length of the second protruding portion is formed to be larger than the protruding length of the first protruding portion.
